(19) United States
(12) Patent Application Publication
(10) Pub. No.: US 2025/0149233 A1
(43) Pub. Date: May 8, 2025

(54) COIL COMPONENT

(71) Applicant: SAMSUNG ELECTRO-MECHANICS CO., LTD., Suwon-si (KR)

(72) Inventors: Tae Hyun Kim, Suwon-si (KR); Byeong Cheol Moon, Suwon-si (KR); Dong Hwan Lee, Suwon-si (KR); Dong Jin Lee, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/816,570

(22) Filed: Aug. 27, 2024

(30) Foreign Application Priority Data
Nov. 8, 2023 (KR) 10-2023-0153202

(51) Int. Cl. H01F 27/30; H01F 5/04; H01F 27/32

(52) U.S. Cl. CPC H01F 27/306; H01F 5/04; H01F 27/324

(57) ABSTRACT

A coil componenti includes: a body having a first surface, a second surface opposing the first surface in a first direction, and a plurality of side surfaces connecting the first surface and the second surface to each other; a support member disposed inside the body; and first and second coils disposed on opposite sides of the support member, in which the first coil includes a first coil layer, a first lead portion disposed between the first coil layer and the support member, and a first conductive via connecting the first coil layer and the first lead portion to each other, and the second coil includes a second coil layer, a second lead portion disposed between the second coil layer and the support member, and a second conductive via connecting the second coil layer and the second lead portion to each other.

### CROSS-REFERENCE TO RELATED APPLICATION(S)

This application claims the benefit of priority to Korean Patent Application No. 10-2023-0153202 filed on Nov. 8, 2023 in the Korean Intellectual Property Office, the disclosure of which is incorporated herein by reference in its entirety.

### TECHNICAL FIELD

The present disclosure relates to a coil component.

### BACKGROUND

In accordance with miniaturization and thinning of electronic devices such as a digital television (TV), a mobile phone, and a laptop computer, miniaturization and thinning of coil components used in such electronic devices have been demanded. In order to satisfy such a demand, research and development of various winding type or thin film type coil components have been actively conducted.

Meanwhile, in a coupled inductor, which has the advantage of reducing a mounting area of a coil component, two or more coils may be arranged in vertical and horizontal directions based on a mounting surface of the component. In a coupled inductor in which two or more coils are arranged in the vertical direction, the coils may have to be elongated to establish connection to external electrodes positioned below, which may have a negative effect on component characteristics.

### SUMMARY

An aspect of the present disclosure may provide a coil component with improved component characteristics by improving a connection structure with external electrodes.

According to an aspect of the present disclosure, a coil component includes: a body having a first surface, a second surface opposing the first surface in a first direction, and a plurality of side surfaces connecting the first surface and the second surface to each other; a support member disposed inside the body; and first and second coils disposed on opposite sides of the support member, in which the first coil includes a first coil layer, a first lead portion disposed between the first coil layer and the support member, and a first conductive via connecting the first coil layer and the first lead portion to each other, and the second coil includes a second coil layer, a second lead portion disposed between the second coil layer and the support member, and a second conductive via connecting the second coil layer and the second lead portion to each other.

According to another aspect of the present disclosure, a coil component includes: a body having a first surface, a second surface opposing the first surface in a first direction, and a plurality of side surfaces connecting the first surface and the second surface to each other; a support member disposed inside the body; and first and second coils disposed on opposite sides of the support member, in which the first and second coils respectively include a plurality of coil layers spaced apart from each other in the first direction, a thickness of a coil layer closest to the support member in the first direction among the plurality of coil layers of the first coil is smaller than a thickness of a remaining coil layer of the first coil, and a thickness of a coil layer closest to the support member in the first direction among the plurality of coil layers of the second coil is smaller than a thickness of a remaining coil layer of the second coil.

According to still another aspect of the present disclosure, a coil component includes: a body; a support member disposed inside the body; and first and second coils disposed on opposite sides of the support member in a first direction, in which the first coil includes a first coil layer having at least one coil turn around a first core and a first lead portion disposed on a different level from the first coil layer in the first direction, the first lead portion having a flat shape without having a coil turn, and the second coil includes a second coil layer having at least one coil turn around a second core and a second lead portion disposed on a different level from the second coil layer in the first direction, the second lead portion having a flat shape without having a coil turn.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view illustrating a coil component according to an exemplary embodiment in the present disclosure;

FIG. 2 is an exploded perspective view illustrating a coil connection structure of the coil component of FIG. 1;

FIG. 3 is a plan view of the coil component of FIG. 1 when viewed from above;

FIG. 4 is a plan view of an upper coil (first coil) of the coil component of FIG. 1 when viewed from above;

FIG. 5 is a plan view of a lower coil (second coil) of the coil component of FIG. 1 when viewed from above;

FIG. 6 is a cross-sectional view taken along line I-I′ of FIG. 1;

FIG. 7 is a cross-sectional view taken along line II-II′ of FIG. 1;

FIG. 8 is a view illustrating a coil component according to a modified example of the exemplary embodiment in the present disclosure and corresponding to a cross-sectional view taken along line I-I′ of FIG. 6; and

FIG. 9 is a view illustrating the coil component according to the modified example of the exemplary embodiment in the present disclosure and corresponding to a cross-sectional view taken along line II-II′ of FIG. 7.

### DETAILED DESCRIPTION

Terms used in the present specification are used only in order to describe specific exemplary embodiments rather than limiting the present disclosure. Singular forms are intended to include plural forms unless the context clearly indicates otherwise.

It is to be understood that the terms “include” or “have” used here specify the presence of features, numbers, steps, operations, components, parts, or combinations thereof mentioned in the present specification, or combinations thereof, but do not preclude the presence or addition of one or more other features, numbers, steps, operations, components, parts, or combinations thereof.

In addition, throughout the specification, “on” does not necessarily mean that any element is positioned on an upper side based on a gravity-direction, but means that any element is positioned above or below a target portion.

Further, a term “couple” not only refers to a case where respective components are in physically direct contact with each other, but also refers to a case where the respective components are in contact with another component with another component interposed therebetween, in a contact relationship between the respective components.

Since sizes and thicknesses of the respective components illustrated in the drawings are arbitrarily illustrated for convenience of explanation, the present disclosure is not necessarily limited to those illustrated in the drawings. In the drawings, an X-direction refers to a first direction or a T direction, a Y-direction refers to a second direction or an L direction, and a Z-direction refers to a third direction or a W direction.

Hereinafter, exemplary embodiments in the present disclosure will be described in detail with reference to the accompanying drawings. The exemplary embodiments in the present disclosure may be modified in many different forms and the scope of the present disclosure should not be limited to the exemplary embodiments set forth herein. Rather, the exemplary embodiments are provided to fully convey the concept of the present disclosure to those having ordinary skill in the art. In the drawings, the shapes and dimensions may be exaggerated for clarity, and the same reference numerals will be used throughout to designate the same or like components.

Various kinds of electronic components may be used in electronic devices, and various kinds of coil components may be appropriately used between these electronic components depending on their purposes in order to remove noise, or the like. That is, the coil components used in the electronic devices may be a power inductor, high frequency (HF) inductors, a general bead, a bead for a high frequency (GHz), a common mode filter, and the like.

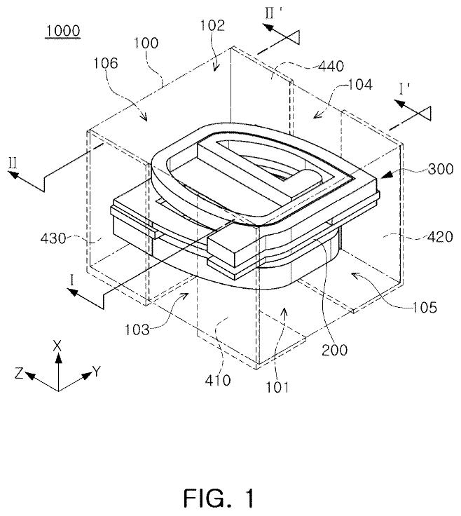

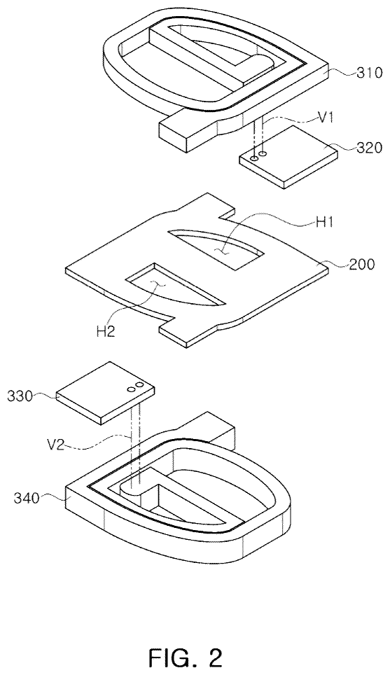

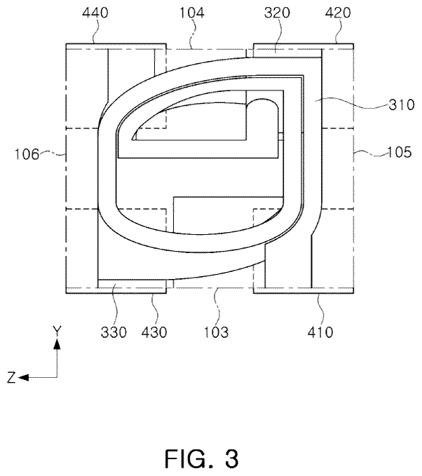

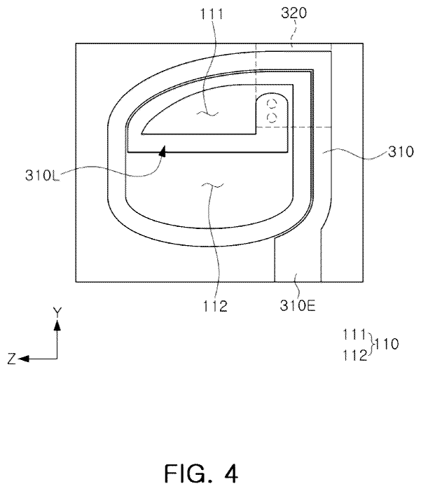

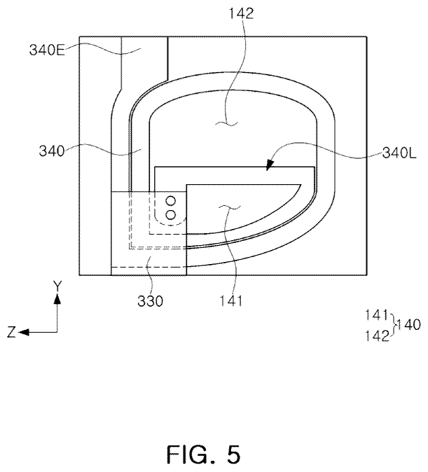

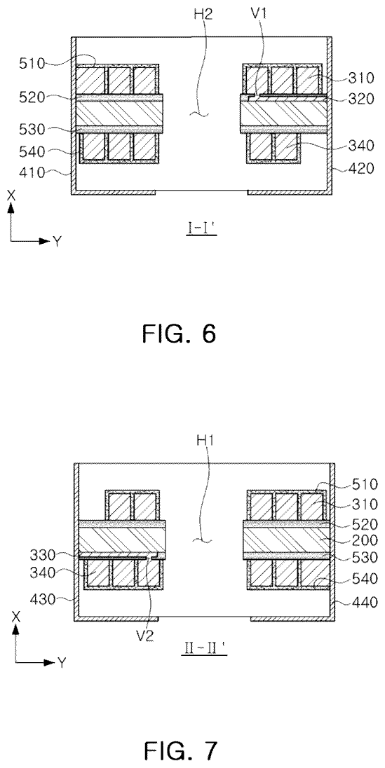

FIG. 1 is a schematic perspective view illustrating a coil component according to an exemplary embodiment in the present disclosure. FIG. 2 is an exploded perspective view illustrating a coil connection structure of the coil component of FIG. 1. FIG. 3 is a plan view of the coil component of FIG. 1 when viewed from above. FIG. 4 is a plan view of an upper coil (first coil) of the coil component of FIG. 1 when viewed from above. FIG. 5 is a plan view of a lower coil (second coil) of the coil component of FIG. 1 when viewed from above. FIG. 6 is a cross-sectional view taken along line I-I′ of FIG. 1. FIG. 7 is a cross-sectional view taken along line II-II′ of FIG. 1.

Referring to FIGS. 1 through 3, a coil component 1000 according to an exemplary embodiment in the present disclosure may include a body 100, a support member 200, a first coil (310 and 320), and a second coil (330 and 340), and may further include first to fourth external electrodes 410, 420, 430, and 440. To facilitate understanding of the exemplary embodiment, insulating layers 520 and 530 and insulating films 510 and 540 are not illustrated in FIGS. 1 through 3.

The body 100 may form an appearance of the coil component 1000 according to an exemplary embodiment in the present disclosure, and may embed a coil portion 300 and the support member 200 therein.

The coil portion 300 and the like may be disposed inside the body 100, and the body 100 may form an overall appearance of the coil component 1000. The body 100 may have a first surface 101 and a second surface 102 opposing each other in the first direction (X-direction) and a plurality of side surfaces (first to fourth side surfaces 103 to 106) connecting the first and second surfaces to each other. Specifically, the first side surface 103 and the second side surface 104 opposing each other in the second direction (Y-direction) connect the first surface 101 and the second surface 102 to each other, and the third side surface 105 and the fourth side surface 106 opposing each other in the third direction (Z-direction) connect the first surface 101 and the second surface 102 to each other. Here, the first direction (X-direction), the second direction (Y-direction), and the third direction (Z-direction) may be perpendicular to one another. The first direction (X-direction) may correspond to a thickness direction of the body 100, the support member 200, and the like. In the following description, the first direction (X-direction), the second direction (Y-direction), and the third direction (Z-direction) each represent both directions. For example, the first direction (X-direction) includes both upward and downward directions in the drawings.

The body 100 may include a resin and a magnetic material. Specifically, the body 100 may be formed by stacking one or more magnetic composite sheets in which the magnetic material is dispersed in the resin. The magnetic material may be ferrite or magnetic metal powder. The ferrite may be, for example, at least one of spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrite such as B—Zn-based ferrite, Ba—Mg-based ferrite, Ba—Ni-based ferrite, Ba—Co-based ferrite, or Ba—Ni—Co-based ferrite, garnet type ferrite such as Y-based ferrite, or Li-based ferrite. The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, or Fe—Cr—Al-based alloy powder. The magnetic metal powder may be amorphous or crystalline. For example, the magnetic metal powder may be Fe—Si—B—Cr based amorphous alloy powder, but is not necessarily limited thereto. The ferrite and the magnetic metal powder may each have an average diameter of about 0.1 μm to 30 μm, but are not limited thereto. The body 100 may include two or more kinds of magnetic materials dispersed in the resin. Here, different kinds of magnetic materials mean that the magnetic materials dispersed in the resin are distinguished from each other by any one of an average diameter, a composition, crystallinity, and a shape. The resin may include epoxy, polyimide, liquid crystal polymer (LCP), or the like, or mixtures thereof, but is not limited thereto.

As an example of a manufacturing method, the body 100 may be formed by a stacking method. Specifically, a plurality of unit stacks for manufacturing the body 100 may be prepared and stacked on and under the coil portion 300. Here, the unit stack may be manufactured in a sheet shape by mixing magnetic metal particles, a thermosetting resin, and organic materials such as a binder and a solvent with one another to prepare slurry, applying the slurry at a thickness of several ten micrometers on a carrier film by a doctor blade method, and then drying the slurry. Therefore, the unit stack may be manufactured in a form in which the magnetic particles are dispersed in the thermosetting resin such as an epoxy resin or a polyimide resin.

Meanwhile, the body 100 may include cores 110 and 140 penetrating through the support member 200 and the coil portion 300 described below. The cores may be formed by filling through-holes penetrating through centers of the coil portion 300 and the support member 200 with magnetic composite sheets containing a magnetic material. Accordingly, the first core 110 may be formed in the first coil (310 and 320) and the second core 140 may be formed in the second coil (330 and 340), which will be described in detail below in the description of the coils.

The support member 200 may be disposed inside the body 100 and support the coil portion 300. During trimming for forming the cores 110 and 140, a central portion of the support member 200 may be removed to form a through-hole H. More specifically, the through-hole H may include a first through-hole H₁ overlapping a first region 111 and a fourth region 142, and a second through-hole H₂ overlapping a second region 112 and a third region 141. The first through-hole H₁ and the second through-hole H₂ may be spaced apart from each other in the second direction (Y-direction). The first to fourth regions 111, 112, 141, and 142 will be described later.

The support member 200 may have one surface facing the second surface 102 of the body 100 (an upper surface in FIG. 2) and the other surface facing the first surface 101 of the body 100 (a lower surface in FIG. 2). The support member 200 may not include via holes penetrating through one surface and the other surface thereof. Accordingly, the first coil (310 and 320) and the second coil (330 and 340) may not be physically connected to each other.

Meanwhile, the support member 200 may be formed of an insulating material including a thermosetting insulating resin such as an epoxy resin, a thermoplastic insulating resin such as a polyimide resin, or a photosensitive insulating resin or be formed of an insulating material having a reinforcing material such as a glass fiber or an inorganic filler impregnated in such an insulating resin. As an example, the support member 200 may be formed of an insulating material such as prepreg, an Ajinomoto Build-up Film (ABF), FR-4, a Bismaleimide Triazine (BT) resin, or a photoimagable dielectric (PID), but is not limited thereto. As a material of the inorganic filler, one or more materials selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used. In a case where the support member 200 is formed of the insulating material including the reinforcing material, the support member 200 may provide more excellent rigidity. In a case where the support member 200 is formed of an insulating material that does not include a glass fiber, the support member 200 may be advantageous in decreasing a thickness of the coil component 1000 according to the present exemplary embodiment. In addition, a volume occupied by the coil portion 300 and/or the magnetic metal powder may be increased on the basis of the body 100 having the same size, such that component characteristics may be improved. In a case where the support member 200 is formed of the insulating material including the photosensitive insulating resin, the number of processes for forming the coil portion 300 may be decreased, which may be advantageous in reducing a production cost and forming fine vias. A thickness of the support member 200 may be, for example, 10 μm or more and 50 μm or less, but is not limited thereto.

The coil connection structure will be described with reference to FIG. 2.

The coil component 1000 according to the present exemplary embodiment may include the first coil (310 and 320) and the second coil (330 and 340). That is, the coil component according to the present exemplary embodiment may be an array type coil component, and may specifically be a coupled inductor. However, the coil component according to the present exemplary embodiment is not necessarily limited thereto.

As described below, the first coil (310 and 320) and the second coil (330 and 340) may be spaced apart from each other in the first direction (X-direction). That is, the first coil (310 and 320) and the second coil (330 and 340) are disposed on opposite sides of the support member 200, respectively. Specifically, the first coil (310 and 320) may be disposed on one surface (an upper surface in FIG. 2) of the support member 200, and the second coil (330 and 340) may be disposed on the other surface of the support member 200 (a lower surface in FIG. 2). For convenience, the first coil (310 and 320) may be referred to as the upper coil and the second coil (330 and 340) may be referred to as the lower coil. That is, the coil component 1000 according to the present exemplary embodiment may be a coil array in which coils are arranged in the vertical direction.

The first coil (310 and 320) will be described with reference to FIGS. 4 and 6.

The first coil (310 and 320) may include a plurality of coil layers in the first direction (X-direction). That is, the first coil (310 and 320) may include the plurality of coil layers arranged to be spaced apart from each other in the first direction (X-direction). That is, the coil of the coil component 1000 according to the present exemplary embodiment may have a structure in which the plurality of coil layers are stacked in the first direction (X-direction). In the drawings, only two coil layers 310 and 320 are illustrated as the first coil. However, in the first coil, a plurality of first coil layers 310 may be formed as describe below to form the plurality of coil layers together with a first lead portion 320.

The first coil may include the first coil layer 310, the first lead portion 320, and a first conductive via V1. Specifically, the first coil may include the first coil layer 310, the first lead portion 320 disposed between the first coil layer 310 and the support member 200, and the first conductive via V1 connecting the first coil layer 310 and the first lead portion 320 to each other.

The first coil layer 310 may have a planar spiral shape forming at least one turn around the first core 110. Unlike the first lead portion 320 described below, the first coil layer 310 may be a portion of the coil that substantially forms a turn around the first core 110.

In the drawings, only one first coil layer 310 is illustrated, but a plurality of first coil layers 310 may be formed to be spaced apart from each other in the first direction (X-direction), and may be connected to each other through a via. In the following description, a case where one first coil layer 310 is formed will be described, but the present exemplary embodiment is not limited thereto.

The first coil layer 310 may form at least one turn around the first core 110, and a portion of the first coil layer 310 may cross the first core 110. The portion of the first coil layer 310 crossing the first core 110 may be referred to as a first straight portion 310L. Referring to FIG. 4, the first straight portion 310L crosses the first core 110 in the third direction (Z-direction).

The first coil layer 310 may form a turn from the first straight portion 310L to an inner end of the first coil layer 310. That is, an additional turn may be formed in only a portion of the first core 110. The portion of the first core 110 in which the additional turn is formed may be referred to as the first region 111. A remaining portion of the first core 110 in which no additional turn is formed may be referred to as the second region 112.

The first region 111 and the second region 112 may be spaced apart from each other based on the first straight Specifically, the first region 111 and the portion 310L. second region 112 may be spaced apart from each other in the second direction (Y-direction). The first region 111 may be disposed closer to the second side surface 104 of the body 100 than the second region 112. The first core 110 may have a circular or oval shape when viewed in the first direction (X-direction), and the first region 111 and the second region 112 may each have a shape obtained by cutting the circular or oval shape.

The first region 111 and the second region 112 may overlap the first and second through-holes H₁ and H₂, respectively. Here, “overlapping” may mean overlapping when viewed from the first direction (X-direction).

A coupling coefficient k of the coupled inductor may be adjusted by adjusting areas of the first region 111 and the third region 141 described below. Specifically, the coupling coefficient k between the first coil and the second coil may be adjusted by adjusting the degree of overlap between the first region 111 and the third region 141. Here, “overlapping” may mean overlapping of disposition regions when viewed from the first direction (X-direction). In the drawings, the first region 111 and the third region 141 are illustrated as not overlapping each other, but the first region 111 and the third region 141 may partially overlap each other. The first and third regions 111 and 141 are not limited thereto, and the first region 111 and the third region 141 may be spaced apart from each other in the second direction (Y-direction).

One end 310E of the first coil layer 310 may be connected to the first external electrode 410, and the other end or the inner end of the first coil layer 310 may be connected to the first lead portion 320 described below through the first conductive via V1. Specifically, the one end 310E of the first coil layer 310 may extend to the first side surface 103 of the body 100 and be connected to the first external electrode 410 disposed on the first side surface 103.

The one end 310E of the first coil layer 310 may be adjacent to the third side surface 105 among the third and fourth side surfaces 105 and 106 of the body 100. That is, the first coil layer 310 may extend to the first side surface 103 of the body 100 in such a way as to be adjacent to a corner formed by the first side surface 103 and the third side surface 105 of the body 100.

The first lead portion 320 may be connected to the second external electrode 420. The first lead portion 320 may serve to connect the first coil layer 310 to the second external electrode 420.

The first lead portion 320 may be disposed between the first coil layer 310 and the support member 200. The first lead portion 320 may be a coil layer closest to the support member 200 in the first direction (X-direction) among the plurality of coil layers of the first coil. That is, the first lead portion 320 may refer to a coil layer closest to the support member 200 among the coil layers on the upper surface of the support member 200.

The first lead portion 320 may be a portion of the coil that does not substantially form a turn of the coil. That is, in the first coil, only the first coil layer 310 excluding the first lead portion 320 may form at least one turn around the core 110.

An average thickness of the first lead portion 320 may be smaller than an average thickness of the remaining coil layer, that is, an average thickness of the first coil layer 310. Here, the thickness means a length in the first direction (X-direction). The average thickness may be measured in the following manner. First, the coil component may be polished in the third direction (Z-direction) to prepare a sample in which cross sections of the first coil layer 310 and the first lead portion 320 are exposed. Next, the collected cross-sectional sample may be observed with an optical microscope or the like to confirm cross-sectional structures of the first lead portion 320 and the first coil layer 310 as illustrated in FIG. 6. At this time, the length in the first direction (X-direction) may be measured at five points arranged at equal intervals in the second direction (Y-direction) in the first lead portion 320 and the first coil layer 310, and an arithmetic mean of the lengths at the five points may be calculated to calculate the average thickness.

The first lead portion 320 may have an average line width larger than that of the remaining coil layer, that is, an average line width of the first coil layer 310. Here, a line width of the first lead portion 320 may mean a length of the first lead portion 320 in the third direction (Z-direction). The average line width may be measured in the following manner. First, the coil component may be polished in the first direction (X-direction) to prepare a sample in which the cross sections of the first coil layer 310 and the first lead portion 320 are exposed. Next, the collected cross-sectional sample may be observed with an optical microscope or the like to measure the line widths of the first coil layer 310 and the first lead portion 320, that is, the lengths of the first coil layer 310 and the first lead portion 320 in the third direction (Z-direction). At this time, the length in the third direction (Z-direction) may be measured at five points arranged at equal intervals in the second direction (Y-direction) in the first coil layer 310 and the first lead portion 320, and an arithmetic mean of the lengths at the five points may be calculated to calculate the average line width.

The first lead portion 320 may be adjacent to the third side surface 105 among the third and fourth side surfaces 105 and 106 of the body 100.

In an existing vertical coupled inductor, that is, an inductor in which a plurality of coils are arranged in a vertical direction based on a mounting surface (lower surface), the coils may have to be elongated to establish connection to external electrodes positioned below. In other words, there is a length difference between the upper and lower coils, which may cause a direct current resistance (Rdc) difference between the two coils. Such a direct current resistance (Rdc) difference causes a difference in capacity of the final coil component.

According to the present disclosure, the lead portions 320 and 330 for connecting the coil portion 300 to the electrodes are implemented as coil layers closest to the support member 200, and the first coil and the second coil may have a point symmetric relationship. Therefore, the length difference between the upper and lower coils may become close to 0, thereby improving an ability to design the capacity of the coil component.

In addition, the coil layer (lead portion) that does not form a turn is implemented as a separate layer (a layer closest to the support member) having a small thickness, which facilitates design of another coil layer that forms a turn in the coil component. Further, as the degree of freedom of design of the coil layer is improved, adjustment of the first to fourth regions 111, 112, 141, and 142 may become easier.

The first conductive via V1 may connect the first coil layer 310 and the first lead portion 320 to each other. A plurality of first conductive vias V1 may be formed and may penetrate through the first insulating layer 520 described below. The first conductive via V1 may connect the inner end of the first coil layer 310 and the first lead portion 320 to each other.

The second coil (330 and 340) will be described with reference to FIGS. 5 and 7. The description of the first coil (310 and 320) may be analogously applied to the description of the second coil (330 and 340), but the second coil (330 and 340) will be described in detail below for clear explanation.

The second coil (330 and 340) may include a plurality of coil layers in the first direction (X-direction). That is, the second coil (330 and 340) may include the plurality of coil layers arranged to be spaced apart from each other in the first direction (X-direction). That is, the coil of the coil component 1000 according to the present exemplary embodiment may have a structure in which the plurality of coil layers are stacked in the first direction (X-direction). In the drawings, only two coil layers 330 and 340 are illustrated as the second coil. However, in the second coil, a plurality of second coil layers 340 may be formed as describe below to form the plurality of coil layers together with a second lead portion 330.

The second coil may include the second coil layer 340, the second lead portion 330, and a second conductive via V2. Specifically, the second coil may include the second coil layer 340, the second lead portion 330 disposed between the second coil layer 340 and the support member 200, and the second conductive via V2 connecting the second coil layer 340 and the second lead portion 330 to each other.

The second coil layer 340 may have a planar spiral shape forming at least one turn around the second core 140. Unlike the second lead portion 330 described below, the second coil layer 340 may be a portion of a coil that substantially forms a turn around the second core 140.

In the drawing, only one second coil layer 340 is illustrated, but a plurality of second coil layers 340 may be formed to be spaced apart from each other in the first direction (X-direction), and may be connected to each other through a via. In the following description, a case where one second coil layer 340 is formed will be described, but the present exemplary embodiment is not limited thereto.

The second coil layer 340 may form at least one turn around the second core 140, and a portion of the second coil layer 340 may cross the second core 140. The portion of the second coil layer 340 crossing the second core 140 may be referred to as a second straight portion 340L. Referring to FIG. 5, the second straight portion 340L crosses the second core 140 in the third direction (Z-direction).

The second coil layer 340 may form a turn from the second straight portion 340L to an inner end of the second coil layer 340. That is, an additional turn may be formed in only a portion of the second core 140. The portion of the second core 140 in which the additional turn is formed may be referred to as the third region 141. A remaining portion of the second core 140 in which no additional turn is formed may be referred to as the fourth region 142.

The third region 141 and the fourth region 142 may be spaced apart from each other based on the second straight portion 340L. Specifically, the third region 141 and the fourth region 142 may be spaced apart from each other in the second direction (Y-direction). The third region 141 may be disposed closer to the first side surface 103 of the body 100 than the fourth region 142. The second core 140 may have a circular or oval shape when viewed in the first direction (X-direction), and the third region 141 and the fourth region 142 may each have a shape obtained by cutting the circular or oval shape.

The third region 141 and the fourth region 142 may overlap the second and first through-holes H₂ and H₁, respectively. Here, “overlapping” may mean overlapping when viewed from the first direction (X-direction).

One end 340E of the second coil layer 340 may be connected to the fourth external electrode 440, and the other end or the inner end of the second coil layer 340 may be connected to the second lead portion 330 described below through the second conductive via V2. Specifically, the one end 340E of the second coil layer 340 may extend to the second side surface 104 of the body 100 and be connected to the fourth external electrode 440 disposed on the second side surface 104.

The one end 340E of the second coil layer 340 may be adjacent to the fourth side surface 106 among the third and fourth side surfaces 105 and 106 of the body 100. That is, the second coil layer 340 may extend to the second side surface 104 of the body 100 in such a way as to be adjacent to a corner formed by the second side surface 104 and the fourth side surface 106 of the body 100.

The second lead portion 330 may be connected to the third external electrode 430. The second lead portion 330 may serve to connect the second coil layer 340 to the third external electrode 430.

The second lead portion 330 may be disposed between the second coil layer 340 and the support member 200. The second lead portion 330 may be a coil layer closest to the support member 200 in the first direction (X-direction) among the plurality of coil layers of the second coil. That is, the second lead portion 330 may refer to a coil layer closest to the support member 200 among the coil layers on the lower surface of the support member 200.

The second lead portion 330 may be a portion of the coil that does not substantially form a turn of the coil. That is, in the second coil, only the second coil layer 340 excluding the second lead portion 330 may form at least one turn around the core 140.

A thickness of the second lead portion 330 may be smaller than a thickness of the remaining coil layer, that is, a thickness of the second coil layer 340.

A line width of the second lead portion 330 may be larger than a line width of the remaining coil layer, that is, a line width of the second coil layer 340.

The second lead portion 330 may be adjacent to the fourth side surface 106 among the third and fourth side surfaces 105 and 106 of the body 100.

The second conductive via V2 may connect the second coil layer 340 and the second lead portion 330 to each other. A plurality of second conductive vias V2 may be formed and may penetrate through the second insulating layer 530. The second conductive via V2 may connect the inner end of the second coil layer 340 and the second lead portion 330 to each other.

The coil portion 300 may be a plating pattern formed by a plating method used in the related art, such as a pattern plating method, an anisotropic plating method, or an isotropic plating method, and may be formed to have a multilayer structure by using a plurality of methods among the methods. Meanwhile, examples of a material of the coil portion 300 include conductive materials such as copper (Cu), aluminum (Al), silver (Ag), tin (Sn), gold (Au), nickel (Ni), lead (Pb), titanium (Ti), chromium (Cr), and alloys thereof, but are not limited thereto.

The coil component according to the present exemplary embodiment may further include the first to fourth external electrodes 410, 420, 430, and 440. The first to fourth external electrodes 410 to 440 may be disposed on the body 100 and connected to the first coil layer 310, the first lead portion 320, the second lead portion 330, and the second coil layer 340, respectively.

Specifically, the first external electrode 410 may be connected to one end of the first coil layer 310, the second external electrode 420 may be connected to the first lead portion 320, the third external electrode 430 may be connected to the second lead portion 330, and the fourth external electrode 440 may be connected to one end of the second coil layer 340.

Hereinafter, arrangement of the external electrodes will be described with reference to FIGS. 3 through 5.

The first external electrode 410 may be disposed on the first side surface 103 of the body 100 and connected to the one end 310E of the first coil layer 310. The second external electrode 420 may be disposed on the second side surface 104 of the body 100 and connected to the first lead portion 320. The third external electrode 430 may be disposed on the first side surface 103 of the body 100 and connected to the second lead portion 330. The fourth external electrode 440 may be disposed on the second side surface 104 of the body 100 and connected to the one end 340E of the second coil layer 340.

The first and third external electrodes 410 and 430 may be spaced apart from each other in the third direction (Z-direction). That is, the first external electrode 410 may be disposed closer to the third side surface 105 than the third external electrode 430. Similarly, the second and fourth external electrodes 420 and 440 may be spaced apart from each other in the third direction (Z-direction). That is, the second external electrode 420 may be disposed closer to the third side surface 105 than the fourth external electrode 440.

Further, the first to fourth external electrodes 410 to 440 may extend to the first surface 101 of the body 100. In this case, the first surface 101 of the body 100 may be provided as a mounting surface of the coil component 1000.

The first to fourth external electrodes 410 to 440 may be formed using a paste containing a metal having excellent electrical conductivity, such as a conductive paste containing nickel (Ni), copper (Cu), tin (Sn), or silver (Ag), or alloys thereof. In addition, a plating layer may be provided to cover each of the first to fourth external electrodes 410 to 440. In this case, the plating layers may include one or more selected from the group consisting of nickel (Ni), copper (Cu), and tin (Sn). For example, nickel (Ni) layers and tin (Sn) layers may be sequentially formed in the plating layers.

The coil component according to the present exemplary embodiment may further include the insulating layers 520 and 530 disposed between the plurality of coil layers.

Referring to FIGS. 6 and 7, the insulating layers 520 and 530 may be disposed between the plurality of coil layers 310, 320, 330, and 340. Specifically, the first insulating layer 520 may be disposed between the first coil layer 310 and the first lead portion 320 and cover the first lead portion 320, and the first coil layer 310 may be disposed on the first insulating layer 520. Similarly, the second insulating layer 530 may be disposed between the second lead portion 330 and the second coil layer 340 and cover the second lead portion 330, and the second coil layer 340 may be disposed on the second insulating layer 530.

As described above, the first and second coils may respectively include a plurality of coil layers, and thus, the first and second insulating layers may also respectively include a plurality of layers.

The insulating layers 520 and 530 may be formed of an insulating material including at least one of a thermosetting insulating resin such as an epoxy resin, a thermoplastic insulating resin such as a polyimide resin, or a photosensitive insulating resin or be formed of an insulating material including a reinforcing material such as a glass fiber or an inorganic filler impregnated in such an insulating resin. For example, the insulating layers 520 and 530 may be formed by stacking insulation films on both surfaces of the support member 200 on which the first and second lead portions 320 and 330 are disposed. Specifically, the insulating layers 520 and 530 may be formed by stacking a film type insulating material such as prepreg, an Ajinomoto Build-up Film (ABF), or a photoimagable dielectric (PID) film, but is not limited thereto, and may be formed by applying and then curing a liquid insulating resin.

The insulating films 510 and 540 may be formed on the surfaces of the first and second coil layers 310 and 340. Specifically, in a case where the first and second coil layers 310 and 340 respectively include a plurality of coil layers, the insulating films 510 and 540 may be formed on the surfaces of coil layers farthest from the support member 200 in the first direction (X-direction) (hereinafter, referred to as the outermost coil layers). Hereinafter, the insulating films 510 and 540 will be described on the assumption that the insulating films 510 and 540 are formed on the outermost coil layers 310 and 340.

The insulating films 510 and 540 may integrally cover the outermost coil layers 310 and 340 and the support member 200. Specifically, the insulating films 510 and 540 may be disposed between the outermost coil layers 310 and 340 and the body 100, and between the support member 200 and the body 100. The insulating films 510 and 540 may be formed along the surface of the support member 200 on which the outermost coil layers 310 and 340 are formed, but are not limited thereto. The insulating films 510 and 540 may fill a region such as a space between adjacent turns of the outermost coil layers 310 and 340. The insulating films 510 and 540 are used to electrically separate the outermost coil layers 310 and 340 from the body 100, and may include a known insulating material such as parylene, but are not limited thereto. As another example, the insulating films 510 and 540 may include an insulating material such as an epoxy resin rather than parylene. The insulating films 510 and 540 may be formed by a vapor deposition method, but are not limited thereto. As another example, the insulating films 510 and 540 may be formed by stacking and curing insulation films for forming the insulating films 510 and 540 on both surfaces in a state where the outermost coil layers 310 and 340 are formed, or may be formed by applying and curing an insulation paste for forming the insulating films 510 and 540 on both surfaces in a state where the outermost coil layers 310 and 340 are formed. Meanwhile, for the reason described above, the insulating films 510 and 540 may be omitted in the present exemplary embodiment. That is, when the body 100 has a sufficient electrical resistance at a designed operating current and voltage of the coil component 1000, the insulating films 510 and 540 may be omitted in the present exemplary embodiment.

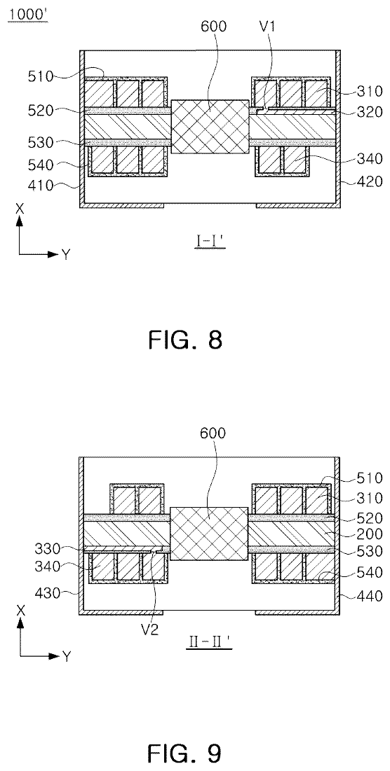

FIG. 8 is a view illustrating a coil component according to a modified example of the exemplary embodiment in the present disclosure and corresponding to a cross-sectional view taken along line I-I′ of FIG. 6. FIG. 9 is a view illustrating the coil component according to the modified example of the exemplary embodiment in the present disclosure and corresponding to a cross-sectional view taken along line II-II′ of FIG. 7.

Hereinafter, the coil component according to the modified example of the exemplary embodiment in the present disclosure will be described with reference to FIGS. 8 and 9.

In the coil component according to the modified example of the exemplary embodiment in the present disclosure, an intermediate layer 600 may be disposed in a through-hole H. Specifically, a support member 200 may have a first through-hole H₁ and a second through-hole H₂, and the intermediate layer 600 may be disposed in at least one of the through-holes H₁ and H₂. In the drawings, the intermediate layer 600 is disposed in both the first and second through-holes H₁ and H₂, but the intermediate layer 600 may be disposed in only one of the first through-hole H₁ and the second through-hole H₂.

The intermediate layer 600 may have a permeability different from that of a body 100. The permeability of the intermediate layer 600 and the permeability of the body 100 may be appropriately set to adjust a coupling coefficient between a first coil and a second coil.

For example, as a method of adjusting the permeability of the intermediate layer 600, a volume (or area) fraction of magnetic particles included in the body 100 and a volume (or area) fraction of magnetic particles included in the intermediate layer 600 may be adjusted to be different from each other. Here, the volume (or area) fraction of the magnetic particles refers to a ratio of a volume (or area) of each magnetic particle to a volume (or area) of the body 100, and the same applies to the intermediate layer 600. The magnetic particles may be formed of the same material, for example, a metal alloy of the same composition to adjust the relative permeability of the intermediate layer 600 and the body 100 based on the volume (or area) fraction of the magnetic particles, but are not necessarily limited thereto.

For convenience, the magnetic particles included in the body 100 may be referred to as first magnetic particles, and the magnetic particles included in the intermediate layer 600 may be referred to as second magnetic particles to distinguish between the magnetic particles included in the body 100 and the magnetic particles included in the intermediate layer 600. That is, the body 100 may include the first magnetic particles at a first volume fraction, and the intermediate layer 600 may include the second magnetic particles at a second volume fraction, and the first and second volume fractions may be different from each other.

In a case where the permeability of the intermediate layer 600 is lower than the permeability of the body 100, the volume (or area) fraction of the second magnetic particles included in the intermediate layer 600 may be smaller than the volume (or area) fraction of the first magnetic particles included in the body 100. In a case where the permeability of the intermediate layer 600 is lower than the permeability of the body 100, the coupling coefficient between the first and second coils may be relatively increased. Here, the relative increase in coupling coefficient means that the coupling coefficient is increased compared to a case where the permeability of the intermediate layer 600 and the permeability of the body 100 are the same as each other. In a case where the permeability of the intermediate layer 600 is relatively low, the amount of magnetic flux flowing into the intermediate layer 600 may be relatively small, and a mutual inductance due to the magnetic flux shared by the first coil and the second coil is increased. Here, the magnetic flux flowing into the intermediate layer 600 may be understood as flowing through the intermediate layer 600 in the second direction (Y-direction) in FIG. 8.

As a result, the mutual inductance of the first coil and the second coil is increased and a leakage inductance formed only in the first coil or the second coil is decreased, and thus, the coupling coefficient between the first coil and the second coil is increased.

Similarly, in a case where the permeability of the intermediate layer 600 is higher than the permeability of the body 100, the volume (or area) fraction of the second magnetic particles included in the intermediate layer 600 may be larger than the volume (or area) fraction of the first magnetic particles included in the body 100. In a case where the permeability of the intermediate layer 600 is higher than the permeability of the body 100, the coupling coefficient between the first and second coils may be relatively decreased. Here, the relative decrease in coupling coefficient means that the coupling coefficient is decreased compared to a case where the permeability of the intermediate layer 600 and the permeability of the body 100 are the same as each other. In a case where the permeability of the intermediate layer 600 is relatively high, the amount of magnetic flux flowing into the intermediate layer 600 may be relatively large, and the mutual inductance due to the magnetic flux shared by the first coil and the second coil is decreased. Here, the magnetic flux flowing into the intermediate layer 600 may be understood as flowing through the intermediate layer 600 in the second direction (Y-direction) in FIG. 8.

As a result, the mutual inductance of the first coil and the second coil is decreased and the leakage inductance formed only in the first coil or the second coil is increased, and thus, the coupling coefficient between the first coil and the second coil is decreased.

A method for checking the intermediate layer 600 is as follows. First, the coil component may be polished in the third direction (Y-direction) to prepare a sample in which the through-hole of the support member is exposed. Next, when the collected cross-sectional sample is observed using a scanning electron microscope (SEM) or the like, a material containing powder with a different particle size from that of the body 100 may be disposed in the through-hole, so that the intermediate layer 600 may be checked. Furthermore, since the intermediate layer 600 may have a different area fraction of magnetic particles from that of the body 100 as described above, the area fraction of the magnetic particles may be calculated by observing the cross-sectional sample. The area fraction of the magnetic particles included in the intermediate layer 600 is different from the area fraction of the magnetic particles included in the body 100, and a permeability relationship between the intermediate layer 600 and the body 100 may be confirmed therefrom.

As set forth above, in the coil component according to the exemplary embodiment in the present disclosure, characteristics of the coil component may be improved by improving the connection structure with the external electrodes.

While example embodiments have been shown and described above, it will be apparent to those skilled in the art that modifications and variations could be made without departing from the scope of the present invention as defined by the appended claims.

What is claimed is:

1. A coil component comprising:
a body having a first surface, a second surface opposing the first surface in a first direction, and a plurality of side surfaces connecting the first surface and the second surface to each other;
a support member disposed inside the body; and
first and second coils disposed on opposite sides of the support member,
wherein the first coil includes a first coil layer, a first lead portion disposed between the first coil layer and the support member, and a first conductive via connecting the first coil layer and the first lead portion to each other, and
the second coil includes a second coil layer, a second lead portion disposed between the second coil layer and the support member, and a second conductive via connecting the second coil layer and the second lead portion to each other.

2. The coil component according to claim 1, wherein an average thickness of the first lead portion is smaller than an average thickness of the first coil layer, and
an average thickness of the second lead portion is smaller than an average thickness of the second coil layer.

3. The coil component according to claim 1, further comprising:
a first insulating layer disposed between the first lead portion and the first coil layer; and
a second insulating layer disposed between the second lead portion and the second coil layer.

4. The coil component according to claim 3, wherein the first conductive via penetrates through the first insulating layer, and
the second conductive via penetrates through the second insulating layer.

5. The coil component according to claim 1, wherein the first coil layer forms at least one turn around a first core, and
the second coil layer forms at least one turn around a second core.

6. The coil component according to claim 5, wherein the first coil layer has a first straight portion crossing the first core, and
the second coil layer has a second straight portion crossing the second core.

7. The coil component according to claim 6, wherein the first coil layer forms a turn from the first straight portion of the first coil layer to an inner end of the first coil layer, and
the second coil layer forms a turn from the second straight portion of the second coil layer to an inner end of the second coil layer.

8. The coil component according to claim 1, wherein the support member has first and second through-holes.

9. The coil component according to claim 8, wherein the body includes a resin and first magnetic particles.

10. The coil component according to claim 9, wherein an intermediate layer including second magnetic particles is disposed in at least one of the first through-hole or the second through-hole,
the body includes the first magnetic particles at a first volume fraction,
the intermediate layer includes the second magnetic particles at a second volume fraction, and
the first volume fraction and the second volume fraction are different from each other.

11. The coil component according to claim 1, wherein the plurality of side surfaces include first and second side surfaces opposing each other in a second direction, and third and fourth side surfaces opposing each other in a third direction,
one end of the first coil layer extends to the first side surface of the body,
the first lead portion extends to the second side surface of the body,
the second lead portion extends to the first side surface of the body, and
one end of the second coil layer extends to the second side surface of the body.

12. A coil component comprising:
a body having a first surface, a second surface opposing the first surface in a first direction, and a plurality of side surfaces connecting the first surface and the second surface to each other;
a support member disposed inside the body; and
first and second coils disposed on opposite sides of the support member,
wherein the first and second coils respectively include a plurality of coil layers spaced apart from each other in the first direction,
an average thickness of a coil layer closest to the support member in the first direction among the plurality of coil layers of the first coil is smaller than an average thickness of a remaining coil layer of the first coil, and
an average thickness of a coil layer closest to the support member in the first direction among the plurality of coil layers of the second coil is smaller than an average thickness of a remaining coil layer of the second coil.

13. The coil component according to claim 12, wherein an average line width of the coil layer closest to the support member in the first direction among the plurality of coil layers of the first coil is larger than an average line width of the remaining coil layer of the first coil, and
an average line width of the coil layer closest to the support member in the first direction among the plurality of coil layers of the second coil is larger than an average line width of the remaining coil layer of the second coil.

14. The coil component according to claim 12, wherein the coil layer closest to the support member in the first direction among the plurality of coil layers of the first coil does not substantially form a turn, and
the coil layer closest to the support member in the first direction among the plurality of coil layers of the second coil does not substantially form a turn.

15. The coil component according to claim 12, wherein the support member does not have a via hole penetrating through both sides of the support member.

16. A coil component comprising:
a body;
a support member disposed inside the body; and
first and second coils disposed on opposite sides of the support member in a first direction,
wherein the first coil includes a first coil layer having at least one coil turn around a first core and a first lead portion disposed on a different level from the first coil layer in the first direction,
the second coil includes a second coil layer having at least one coil turn around a second core and a second lead portion disposed on a different level from the second coil layer in the first direction, and
each of the first and second lead portions is free of a coil turn.

17. The coil component according to claim 16, wherein the first lead portion is disposed between the support member and the first coil layer and connected to the first coil layer using at least one first conductive via, and
the second lead portion is disposed between the support member and the second coil layer and connected to the second coil layer using at least one second conductive via.

18. The coil component according to claim 16, wherein the first coil layer has a first straight portion crossing the first core such that the first core is divided into first and second regions based on the first straight portion,
the second coil layer has a second straight portion crossing the second core such that the second core is divided into third and fourth regions based on the second straight portion, the first region and the fourth region overlapping each other in the first direction, and the second region and the third region overlapping each other in the first direction,
the number of coil turns around the first region of the first core is greater than the number of coil turns around the second region of the first core, and
the number of coil turns around the third region of the second core is greater than the number of coil turns around the fourth region of the second core.

19. The coil component according to claim 18, wherein the first lead portion is disposed between the first region of the first core and the fourth region of the second core,
the second lead portion is disposed between the second region of the first core and the third region of the second core, and
the first and second lead portions do not overlap each other in the first direction.
